(19) United States
(12) Patent Application Publication
(10) Pub. No.: US 2017/0265030 A1
(43) Pub. Date: Sep. 14, 2017

(54) POINT OF INTEREST MANAGEMENT METHOD AND SYSTEM

(71) Applicant: Electronics and Telecommunications Research Institute, Daejeon (KR)

(72) Inventor: Seung-Woog JUNG, Daejeon (KR)

(73) Assignee: Electronics and Telecommunications Research Institute, Daejeon (KR)

(21) Appl. No.: 15/451,619

(22) Filed: Mar. 7, 2017

(30) Foreign Application Priority Data
Mar. 10, 2016 (KR) 10-2016-0028975

(51) Int. Cl. H04W 4/02

(52) U.S. Cl. CPC H04W 4/02

(57) ABSTRACT

Provided is a point of interest management system. The point of interest management system includes a point of stay extraction unit configured to extract a point of stay based on environment collection information received from a smart device, and a point of interest extraction unit configured to calculate a similarity of the point of stay by comparing environmental information of the point of stay with environmental information of a pre-stored point of interest and determine whether to update the point of interest according to a comparison result between the similarity of the point of stay and a reference similarity.

### CROSS-REFERENCE TO RELATED APPLICATIONS

This U.S. non-provisional patent application claims priority under 35 U.S.C. §119 of Korean Patent Application No. 10-2016-0028975, filed on Mar. 10, 2016, the entire contents of which are hereby incorporated by reference.

### BACKGROUND

The present disclosure herein relates to point of interest extraction, and more particularly, to a point of interest management method and system.

Recently, many people use smart devices such as smart phones. Most smart devices have GPS sensors capable of predicting users' locations. Applications on smart devices run based on the current location information of the user. However, most of such applications require more meaningful information, such as which location the user stays currently, or which location the user visits and how long the user stays currently, rather than the exact location information of the user. In addition, as the number of large buildings including various stores such as a large shopping mall, a complex exhibition hall, a subway, an airport, and the like increases recently, there is a growing demand for technologies that effectively locate the user's place or area of interest both indoors and outdoors.

### SUMMARY

The present disclosure provides a point of interest management method and system for extracting a point of stay by using various environment collection information of a smart device and generating a new point of interest and updating an existing point of interest by comparing environmental information of a point of stay and environmental information of a pre-stored point of interest.

An embodiment of the inventive concept provides a point of interest management system including: a point of stay extraction unit configured to extract a point of stay based on environment collection information received from a smart device; and a point of interest extraction unit configured to calculate a similarity of the point of stay by comparing environmental information of the point of stay with environmental information of a pre-stored point of interest and determine whether to update the point of interest according to a comparison result between the similarity of the point of stay and a reference similarity.

In an embodiment, the point of interest management system may further include a new point of interest generation unit configured to generate the point of stay as a new point of interest when the similarity of the point of stay is less than the reference similarity.

In an embodiment, the point of interest extraction unit may set the new point of interest as an optimum point of interest.

In an embodiment, the point of interest management system may further include a point of interest allocation unit configured to allocate the optimum point of interest as a current point of interest of a user.

In an embodiment, the point of interest management system may further include a point of interest update unit configured to update the environmental information of the point of interest based on the environmental information of the point of stay when the similarity of the point of stay is greater than or equal to the reference similarity.

In an embodiment, the point of interest extraction unit may set the point of interest having the updated environmental information as an optimum point of interest.

In an embodiment, the point of interest management system may further include: a point of stay database configured to store the point of stay; and a point of interest database configured to store the point of interest.

In an embodiment, the environment collection information may include Wi-Fi information, Bluetooth information, beacon information, GPS information, gyro information, and accelerometer information.

In an embodiment of the inventive concept, a point of interest management method includes: receiving environment collection information from a smart device; extracting a point of stay based on the environment collection information; comparing environmental information of the point of stay with environmental information of a pre-stored point of interest to calculate a similarity of the point of stay; and determining whether to update the point of interest according to a comparison result between the similarity of the point of stay and a reference similarity.

In an embodiment, the method may further include generating a new point of interest based on the environmental information of the point of stay when the similarity of the point of stay is less than the reference similarity.

In an embodiment, the method may further include setting the new point of interest as an optimum point of interest.

In an embodiment, the method may further include updating the environmental information of the point of interest based on the environmental information of the point of stay when the similarity of the point of stay is greater than or equal to the reference similarity.

In an embodiment, the method may further include setting the point of interest having the updated environmental information as an optimum point of interest.

In an embodiment of the inventive concept, a point of interest management system includes: a point of stay database configured to store a point of stay received from a smart device; and a point of interest extraction unit configured to calculate a similarity of the point of stay by comparing environmental information of the point of stay with environmental information of a pre-stored point of interest and determine whether to update the point of interest according to a comparison result between the similarity of the point of stay and a reference similarity.

In an embodiment, the smart device may include: an environment collection information acquisition unit configured to generate environment collection information by using various information collection devices; a point of stay extraction unit configured to extract the point of stay based on the environment collection information; and a point of stay transmission unit configured to transmit the point of stay.

In an embodiment, the information collection devices may include a Wi-Fi information acquisition unit, a Bluetooth information acquisition unit, a beacon information acquisition unit, a GPS information acquisition unit, a gyro information acquisition unit, and an accelerometer information acquisition unit.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a point of interest management system according to an embodiment of the inventive concept;

FIG. 2 is a block diagram illustrating a smart device according to an embodiment of the inventive concept;

FIG. 3 is a view illustrating environmental information of a point of stay extracted in FIG. 1;

FIG. 4 is a view illustrating point of interest information extracted in FIG. 1;

FIG. 5 is a flowchart illustrating a point of interest management method according to an embodiment of the inventive concept; and

FIG. 6 is a block diagram illustrating a smart device and a point of interest management system according to another embodiment of the inventive concept.

### DETAILED DESCRIPTION

It should be understood that preceding general description and the following detailed description are all illustrative and additional description of the claimed invention is provided. Reference symbols are shown in preferred embodiments of the inventive concept in detail, and their examples are shown in reference drawings. In any case possible, the same reference numerals are used in the description and drawings to refer to the same or similar parts.

Hereinafter, a point of interest management system is used as a device of one example to describe the features and functions of the inventive concept. However, those skilled in the art may easily understand other advantages and performances of the inventive concept according to contents listed herein. In addition, the inventive concept may be implemented or applied also through other embodiments. Moreover, detailed description may be modified or changed according to a perspective view and application without significantly departing from the scope, technical ideas, and another purpose of the inventive concept.

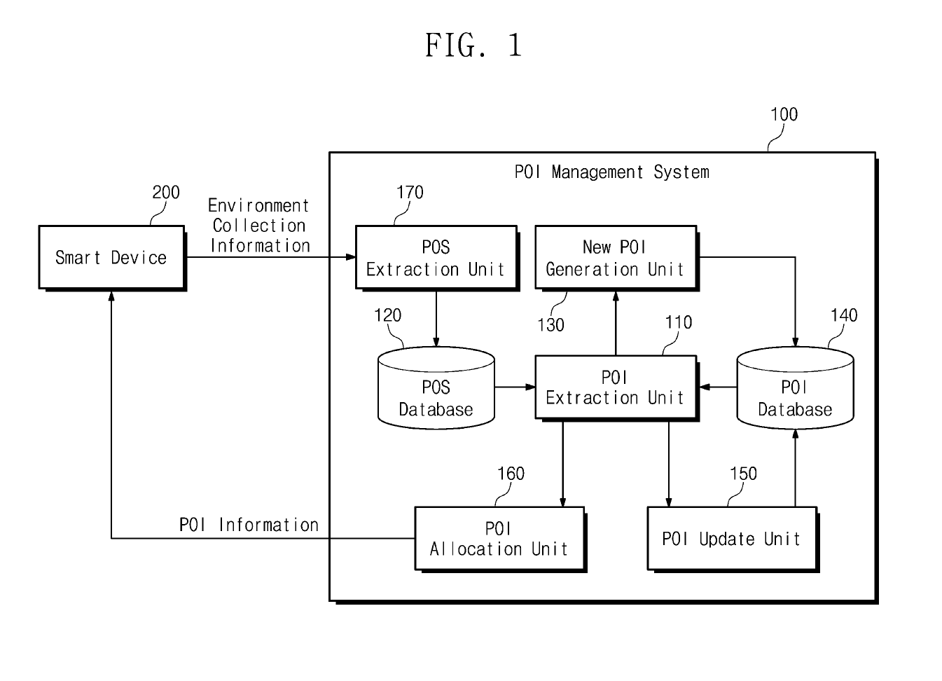

FIG. 1 is a block diagram illustrating a point of interest management system according to an embodiment of the inventive concept. Referring to FIG. 1, a point of interest management system 100 includes a point of interest extraction unit 110, a point of stay database 120, a new point of interest generation unit 130, a point of interest database 140, a point of interest update unit 150, a point of interest allocation unit 160, and a point of stay extraction unit 170. Each unit may be embodied as software, hardware or a combination thereof. The point of interest management system 100 may receive environment collection information from a smart device 200 and provide point of interest information to the smart device 200.

The point of stay extraction unit 170 may receive environment collection information from the smart device 200. For example, the environment collection information may include Wi-Fi information, Bluetooth information, beacon information, GPS information, gyro information, and accelerometer information, which are obtained by the smart device 200. The point of stay extraction unit 170 may extract a point of stay by using such environment collection information. The extracted new point of stay may be stored in the point of stay database 120.

The point of interest extraction unit 110 may extract an optimal point of interest by using the new point of stay stored in the point of stay database 120. For example, when a new point of stay is stored in the point of stay database 120, the point of interest extraction unit 110 may calculate the similarity of the new point of stay by comparing environmental information of the new point of stay and environmental information of a point of interest corresponding to a new point of stay stored in the point of interest database 140. For example, the point of interest extraction unit 110 may select a point of interest corresponding to the new point of stay by using at least one of Wi-Fi information, Bluetooth information, beacon information, GPS information, gyro information, and accelerometer information of the new point of stay.

Exemplarily, the point of interest extraction unit 110 may extract a point of interest by using a clustering technique. The point of interest extraction unit 110 may divide points of interest stored in the point of stay database 140 into a plurality of clusters. The point of interest extraction unit 110 may set one of the points of interest in each cluster as a representative point of interest according to a predetermined criterion.

If the similarity of the new point of stay is less than the set minimum similarity, the new point of interest generation unit 130 may generate a new point of interest by using the new point of stay and store the new point of interest as an optimal point of interest in the point of interest database 140.

If the similarity of the new point of stay is greater than or equal to the set minimum similarity, the point of interest update unit 150 may modify the environment information of the existing point of interest by using the environment information of the new point of stay and set the modified point of interest as the optimum point of interest. The point of interest update unit 150 may update the point of interest database 140 by using the environment information of the modified point of interest.

The point of interest allocation unit 160 may allocate the optimum point of interest set by the point of interest extraction unit 110 as the current point of interest of a user. The point of interest allocation unit 160 may transmit point of interest information including the current point of interest to the smart device 200.

The point of interest management system 100 may extract a point of interest by receiving various environment collection information (for example, Wi-Fi information, Bluetooth information, beacon information, GPS information, gyro information, and accelerometer information) from the smart device 200. In addition, the point of interest management system 100 may maintain up-to-date information by updating a point of interest stored in the point of interest database 140. The point of interest management system 100 provides a point of interest including notions of visit frequency and stay time in addition to simple location information so that it may provide various selection opportunities to users.

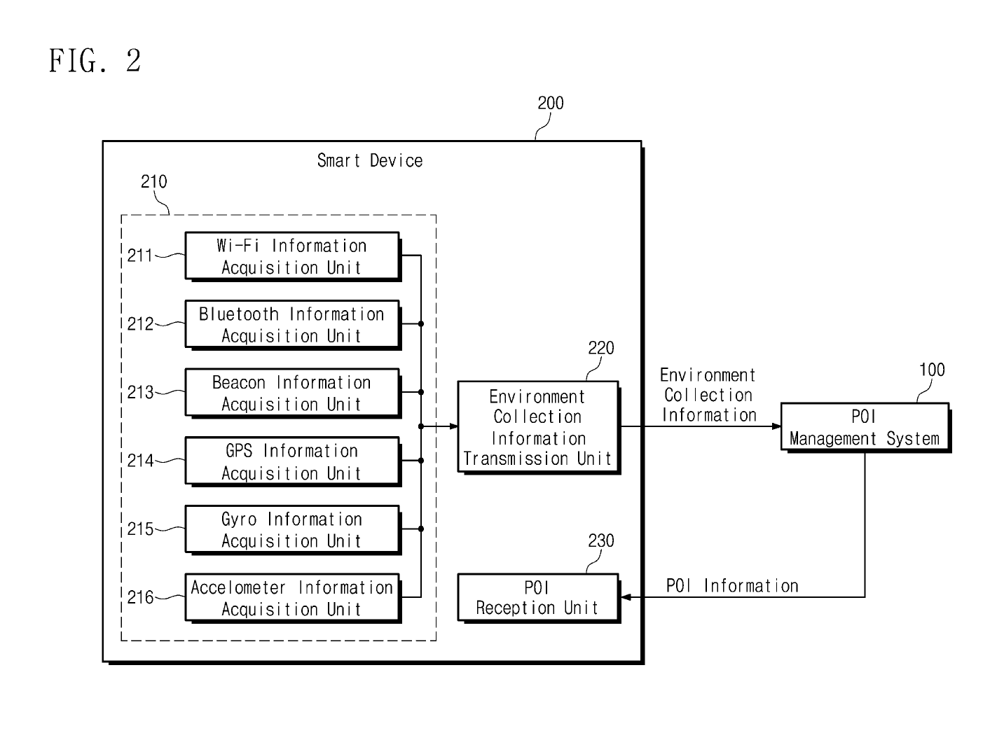

FIG. 2 is a block diagram illustrating a smart device according to an embodiment of the inventive concept. Referring to FIG. 2, the smart device 200 may include an environment collection information acquisition unit 210, an environment collection information transmission unit 220, and a point of interest reception unit 230. For example, the smart device 200 refers to a device (for example, a smart phone and a smart pad) including various sensors and capable of transmitting information collected from the various sensors. The environment collection information acquisition unit 210 includes a Wi-Fi information acquisition unit 211, a Bluetooth information acquisition unit 212, a beacon information acquisition unit 213, a GPS information acquisition unit 214, a gyro information acquisition unit 215, and an accelerometer information acquisition unit 216. However, this is exemplary, and the environment collection information acquisition unit 210 may further include information acquisition units corresponding to various sensors. Each of the information acquisition units 211 to 216 may provide collected information to the environment collection information transmission unit 220. The environment collection information transmission unit 220 may transmit the collected information to the point of interest database 100. The point of interest reception unit 230 may receive point of interest information from the point of interest management system 100. Each unit may be embodied as software, hardware or a combination thereof.

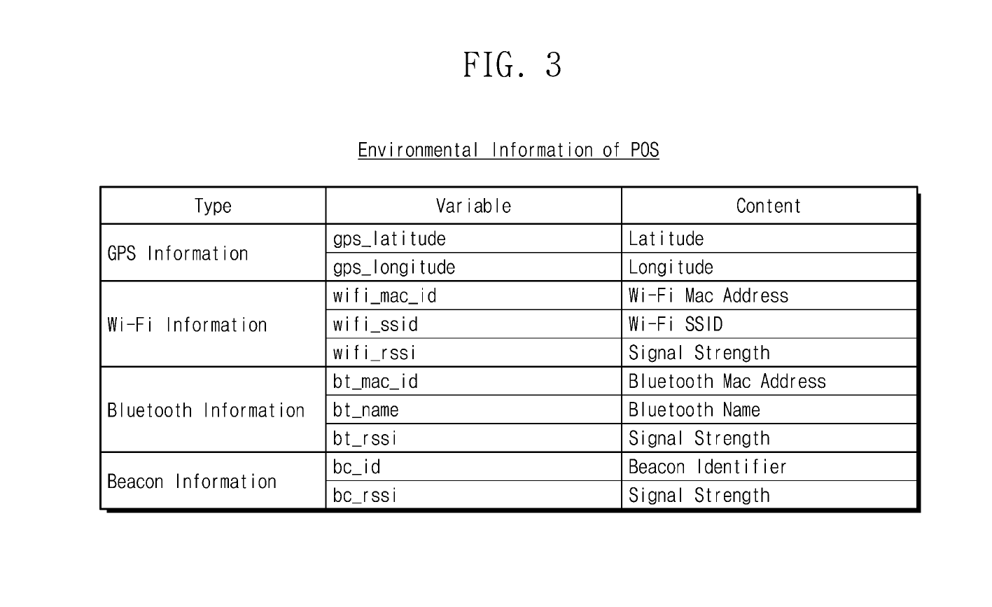

FIG. 3 is a view illustrating environmental information of a point of stay extracted in FIG. 1. Referring to FIGS. 1 to 3, the point of stay extraction unit 170 may receive environment collection information of the smart device 200 to extract a point of stay.

The environment information of the point of stay may include GPS information, Wi-Fi information, Bluetooth information, and beacon information. For example, the GPS information may include latitude and longitude. The Wi-Fi information may include a Wi-Fi MAC address, a Wi-Fi SSID, and a signal strength. The Bluetooth information may include a Bluetooth MAC address, a Bluetooth name, and a signal strength. The beacon information may include a beacon identifier and a signal strength.

However, the environmental information of the point of stay in FIG. 3 is exemplary. Accordingly, the environmental information of the point of stay may further include various items not shown in FIG. 3.

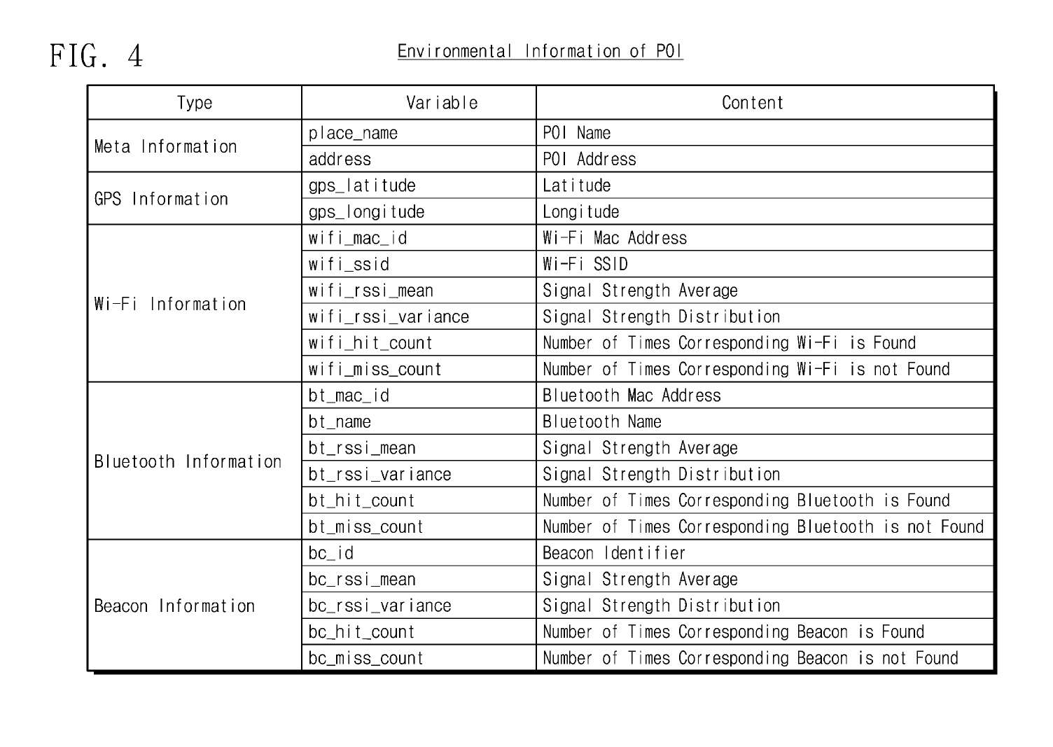

FIG. 4 is a view illustrating point of interest information extracted in FIG. 1. Referring to FIGS. 1 and 4, the point of interest extraction unit 110 may generate the environmental information of a point of interest by using the environmental information of a point of stay.

The environment information of the point of interest may include meta information, GPS information, Wi-Fi information, Bluetooth information, and beacon information. For example, the meta information may include a point of interest name and a point of interest address. The GPS information may include latitude and longitude. The Wi-Fi information may include a Wi-Fi MAC address, a Wi-Fi SSID, a signal strength average, a signal strength distribution, the number of times corresponding Wi-Fi is found, and the number of times corresponding Wi-Fi is not found. The Bluetooth information may include a Bluetooth MAC address, a Bluetooth name, a signal strength average, a signal strength distribution, the number of times corresponding Bluetooth is found, and the number of times corresponding Bluetooth is not found. The beacon information may include a beacon identifier, a signal strength average, a signal strength distribution, the number of times corresponding beacon is found, and the number of times corresponding beacon is not found.

However, the environmental information of the point of interest in FIG. 4 is exemplary. Accordingly, the environmental information of the point of interest may further include various items not shown in FIG. 4.

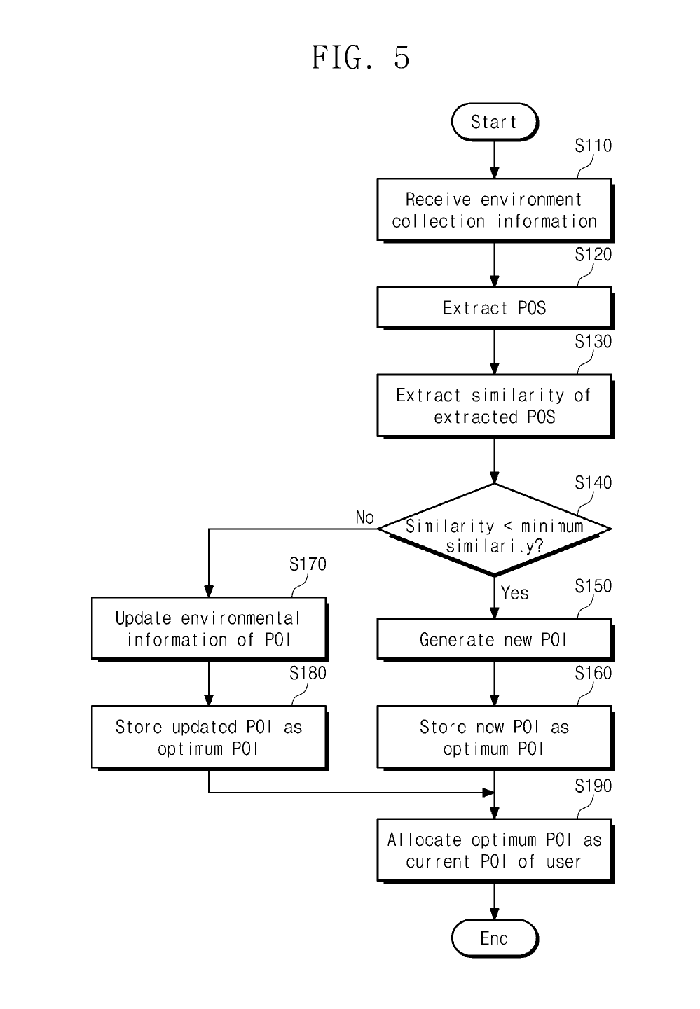

FIG. 5 is a flowchart illustrating a point of interest management method according to an embodiment of the inventive concept. Referring to FIGS. 1 to 6, the point of interest management system 100 may extract a point of interest by using the environment collection information of the smart device 200 and manage the point of interest.

In operation S110, the point of interest management system 100 may receive environment collection information from the smart device 200. For example, the point of stay extraction unit 170 may receive Wi-Fi information, Bluetooth information, beacon information, GPS information, gyro information, and accelerometer information from the smart device 200.

In operation S120, the point of interest management system 100 may extract a point of stay by using the environment collection information of the smart device 200. For example, the point of stay extraction unit 170 may extract a point of stay based on the environment collection information. The point of stay may be extracted through a plurality of criteria. Exemplarily, a stay time may be determined by using the environmental information, and the point of stay may be determined by comparing the stay time with a reference value. The extracted new point of stay may be stored in the point of stay database 120.

In operation S130, the point of interest management system 100 may extract the similarity of the point of stay extracted in operation S120. For example, when a new point of stay is stored in the point of stay database 120, the point of interest extraction unit 110 may calculate the similarity of the new point of stay by comparing environmental information of the new point of stay and environmental information of a point of interest corresponding to the new point of stay, which is stored in the point of interest database 140. For example, the point of interest extraction unit 110 may select a point of interest corresponding to a new point of stay by using at least one of Wi-Fi information, Bluetooth information, beacon information, GPS information, gyro information, and accelerometer information of the new point of stay.

In operation S140, the point of interest management system 100 may compare the similarity of the extracted point of stay with a set minimum similarity. When the similarity of the extracted point of stay is less than the minimum similarity, the method proceeds to operation S150. When the similarity of the extracted point of stay is greater than or equal to the minimum similarity, the method proceeds to operation S170.

In operation S150, the point of interest management system 100 may generate a new point of interest based on the environmental information of the extracted point of stay. For example, if the similarity of the new point of stay is less than the set minimum similarity, the new point of interest generation unit 130 may generate a new point of interest based on the environmental information of the new point of stay.

In operation S160, the point of interest management system 100 may store the new point of interest as an optimum point of interest in the point of interest database 140. For example, the point of interest generation unit 130 may store a new point of interest as an optimum point of interest in the point of interest database 140.

In operation S170, the point of interest management system 100 may update the environmental information of a point of interest based on the environmental information of the extracted point of stay. For example, if the similarity of the new point of stay is greater than or equal to the set minimum similarity, the point of interest update unit 150 may modify the environment information of the existing point of interest by using the environment information of the new point of stay.

In operation S180, the point of interest management system 100 may store the updated point of interest as an optimum point of interest in the point of interest database 140. For example, the point of interest update unit 150 may set the modified point of interest as an optimum point of interest. The point of interest update unit 150 may update the point of interest database 140 by using the environment information of the modified point of interest.

In operation S190, the point of interest management system 100 may allocate the optimum point of interest as the current point of interest of a user. For example, the point of interest allocation unit 160 may allocate the optimum point of interest set by the point of interest extraction unit 110 as the current point of interest of a user. The point of interest allocation unit 160 may transmit point of interest information including the current point of interest to the smart device 200.

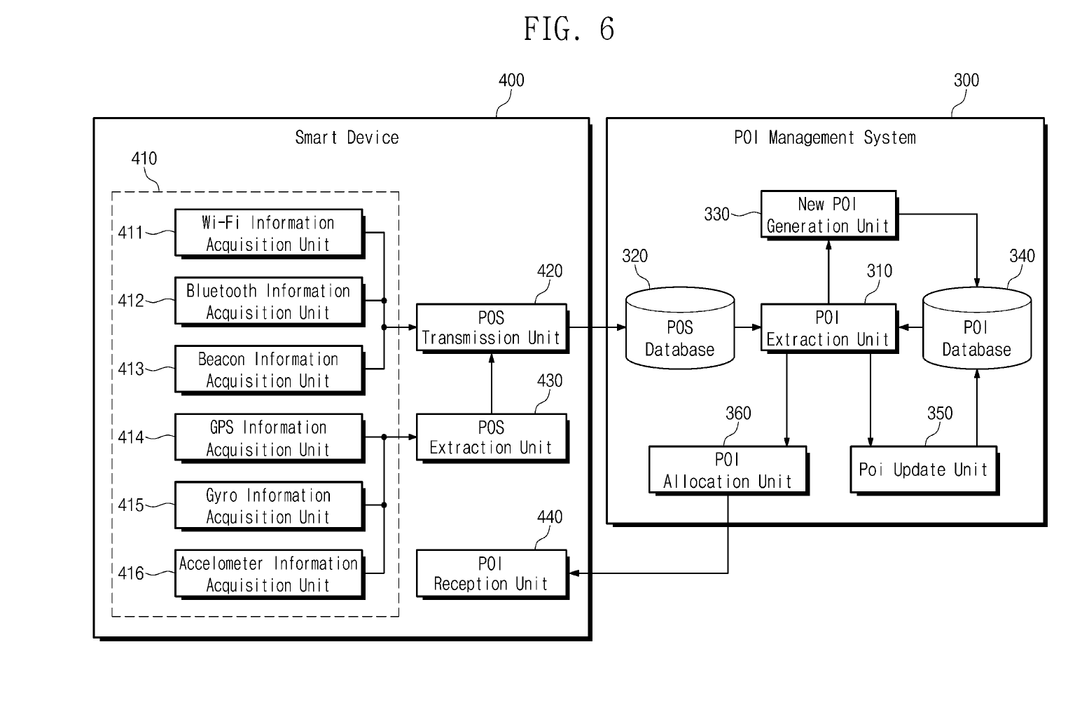

FIG. 6 is a block diagram illustrating a smart device and a point of interest management system according to another embodiment of the inventive concept. Referring to FIG. 6, a point of interest management system 300 includes a point of interest extraction unit 310, a point of stay database 320, a new point of interest generation unit 330, a point of interest database 340, a point of interest update unit 350, and a point of interest allocation unit 360. In addition, a smart device 400 may include an environment collection information acquisition unit 410, a point of stay transmission unit 420, a point of stay extraction unit 430, and a point of interest reception unit 440. The point of interest management system 300 may receive a point of stay from the smart device 400 and provide point of interest information to the smart device 400.

The smart device 200 may extract a point of stay based on the environment collection information acquired by the environment collection information acquisition unit 410. For example, the environment collection information acquisition unit 410 includes a Wi-Fi information acquisition unit 411, a Bluetooth information acquisition unit 412, a beacon information acquisition unit 413, a GPS information acquisition unit 414, a gyro information acquisition unit 415, and an accelerometer information acquisition unit 416. However, this is exemplary, and the environment collection information acquisition unit 410 may further include information acquisition units corresponding to various sensors. Each of the information acquisition units 411 to 416 may provide collected information to the point of stay transmission unit 420 or the point of stay extraction unit 430. Unlike FIG. 6, each of the information acquisition units 411 to 416 may provide collected information to one of the point of stay transmission unit 420 or the point of stay extraction unit 430 according to a setting. Each unit may be embodied as software, hardware or a combination thereof.

The point of stay extraction unit 430 may extract a point of stay based on the environment collection information received from each of the information acquisition units 411 to 416. The point of stay transmission unit 420 may add the environment collection information received from each of the information acquisition units 411 to 416 to the point of stay extracted by the point of stay extraction unit 430. The point of stay transmission unit 420 may transmit the environmental information of the extracted point of stay to the point of interest management system 300. In FIG. 6, the point of stay is extracted by the smart device 400. Accordingly, compared to the smart device 200 of FIG. 2, the smart device 400 of FIG. 6 may reduce the size of data transmitted to the point of interest management system 300.

The point of stay database 320 of the point of interest management system 300 may receive the environment information from the smart device 400 and store it.

The point of interest extraction unit 310 may extract an optimal point of interest by using the new point of stay stored in the point of stay database 320. For example, when a new point of stay is stored in the point of stay database 320, the point of interest extraction unit 310 may calculate the similarity of the new point of stay by comparing environmental information of the new point of stay and environmental information of a point of interest corresponding to the new point of stay, which is stored in the point of interest database 340. For example, the point of interest extraction unit 310 may select a point of interest corresponding to a new point of stay by using at least one of Wi-Fi information, Bluetooth information, beacon information, GPS information, gyro information, and accelerometer information of the new point of stay.

Exemplarily, the point of interest extraction unit 310 may extract a point of interest by using a clustering technique. The point of interest extraction unit 310 may divide points of interest stored in the point of stay database 340 into a plurality of clusters. The point of interest extraction unit 310 may set one of the points of interest in each cluster as a representative point of interest according to a predetermined criterion.

If the similarity of the new of stay is smaller than the set minimum similarity, the new point of interest generation unit 330 may generate a new point of interest by using the new point of stay and store the new point of interest as an optimal point of interest in the point of interest database 340.

If the similarity of the new point of stay is greater than or equal to the set minimum similarity, the point of interest update unit 350 may modify the environment information of the existing point of interest by using the environment information of the new point of stay and set the modified point of interest as the optimum point of interest. The point of interest update unit 350 may update the point of interest database 340 by using the environment information of the modified point of interest.

The point of interest allocation unit 360 according to an embodiment of the inventive concept may allocate the optimum point of interest set by the point of interest extraction unit 310 as the current point of interest of a user. The point of interest allocation unit 360 may transmit point of interest information including the current point of interest to the smart device 400.

The point of interest management system 300 may receive point of stay information from the smart device 400 and extract a point of interest. In addition, the point of interest management system 300 may maintain up-to-date information by updating a point of interest stored in the point of interest database 340. The point of interest management system 300 provides a point of interest including notions of visit frequency and stay time in addition to simple location information so that it may provide various selection opportunities to users.

According to an embodiment of the inventive concept, provided are a point of interest management method and system for extracting a point of stay by using various environment collection information of a smart device and generating a new point of interest and updating an existing point of interest by comparing environmental information of a point of stay and environmental information of a pre-stored point of interest.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A point of interest management system comprising:
a point of stay extraction unit configured to extract a point of stay based on environment collection information received from a smart device; and
a point of interest extraction unit configured to calculate a similarity of the point of stay by comparing environmental information of the point of stay with environmental information of a pre-stored point of interest and determine whether to update the point of interest according to a comparison result between the similarity of the point of stay and a reference similarity.

2. The point of interest management system of claim 1, further comprising a new point of interest generation unit configured to generate the point of stay as a new point of interest when the similarity of the point of stay is less than the reference similarity.

3. The point of interest management system of claim 2, wherein the point of interest extraction unit sets the new point of interest as an optimum point of interest.

4. The point of interest management system of claim 3, further comprising a point of interest allocation unit configured to allocate the optimum point of interest as a current point of interest of a user.

5. The point of interest management system of claim 1, further comprising a point of interest update unit configured to update the environmental information of the point of interest based on the environmental information of the point of stay when the similarity of the point of stay is greater than or equal to the reference similarity.

6. The point of interest management system of claim 5, wherein the point of interest extraction unit sets the point of interest having the updated environmental information as an optimum point of interest.

7. The point of interest management system of claim 1, further comprising:
a point of stay database configured to store the point of stay; and
a point of interest database configured to store the point of interest.

8. The point of interest management system of claim 1, wherein the environment collection information includes Wi-Fi information, Bluetooth information, beacon information, GPS information, gyro information, and accelerometer information.

9. A point of interest management method comprising:
receiving environment collection information from a smart device;
extracting a point of stay based on the environment collection information;
comparing environmental information of the point of stay with environmental information of a pre-stored point of interest to calculate a similarity of the point of stay; and
determining whether to update the point of interest according to a comparison result between the similarity of the point of stay and a reference similarity.

10. The method of claim 9, further comprising generating a new point of interest based on the environmental information of the point of stay when the similarity of the point of stay is less than the reference similarity.

11. The method of claim 10, further comprising setting the new point of interest as an optimum point of interest.

12. The method of claim 9, further comprising updating the environmental information of the point of interest based on the environmental information of the point of stay when the similarity of the point of stay is greater than or equal to the reference similarity.

13. The method of claim 12, further comprising setting the point of interest having the updated environmental information as an optimum point of interest.

14. A point of interest management system comprising:
a point of stay database configured to store a point of stay received from a smart device; and
a point of interest extraction unit configured to calculate a similarity of the point of stay by comparing environmental information of the point of stay with environmental information of a pre-stored point of interest and determine whether to update the point of interest according to a comparison result between the similarity of the point of stay and a reference similarity.

15. The point of interest management system of claim 14, wherein the smart device comprises:
an environment collection information acquisition unit configured to generate environment collection information by using various information collection devices;
a point of stay extraction unit configured to extract the point of stay based on the environment collection information; and
a point of stay transmission unit configured to transmit the point of stay.

16. The point of interest management system of claim 15, wherein the information collection devices comprise a Wi-Fi information acquisition unit, a Bluetooth information acquisition unit, a beacon information acquisition unit, a GPS information acquisition unit, a gyro information acquisition unit, and an accelerometer information acquisition unit.
